(19) United States
(12) Patent Application Publication
(10) Pub. No.: US 2021/0397927 A1
(43) Pub. Date: Dec. 23, 2021

(54) NEURAL NETWORK SYSTEM AND METHOD OF OPERATING THE SAME

(71) Applicant: DELTA ELECTRONICS, INC., Taoyuan City (TW)

(72) Inventors: Yu-Ta CHEN, Taoyuan City (TW); Feng-Ming LIANG, Taoyuan City (TW); Shao-Yi CHIEN, Taoyuan City (TW); Yu TSAO, Taoyuan City (TW); Chen-En JIANG, Taoyuan City (TW)

(21) Appl. No.: 17/349,957

(22) Filed: Jun. 17, 2021

(30) Foreign Application Priority Data
Jun. 17, 2020 (CN) 202010552739.9

(51) Int. Cl. G06N 3/04; G06N 3/08

(52) U.S. Cl. CPC G06N 3/0454; G06N 3/08

(57) ABSTRACT

A neural network system includes at least one memory and at least one processor. The memory is configured to store a front-end neural network, an encoding neural network, a decoding neural network and a back-end neural network. The processor is configured to execute the front-end neural network, the encoding neural network, the decoding neural network and the back-end neural network in the memory to perform operations including: utilizing the front-end neural network to output feature data; utilizing the encoding neural network to compress the feature data, and output compressed data which correspond to the feature data; utilizing the decoding neural network to decompress the compressed data, and output decompressed data which correspond to the feature data; and utilizing the back-end neural network to perform corresponding operations based on the decompressed data. A method of operating a neural network system is also disclosed herein.

### CROSS-REFERENCE TO RELATED APPLICATION

This application claims priority to China Application Serial Number 202010552739.9, filed Jun. 17, 2020, which is herein incorporated by reference in its entirety.

### BACKGROUND

### Field of Invention

The present invention relates to a neural network. More particularly, the present invention relates to a neural network system having multiple segments.

### Description of Related Art

Most deep learning and machine learning use neural networks as their system structures, wherein neural networks have a variety of mathematic calculations in order to obtain the target data. To enhance the computing performance of a neural network, a set of neural network will be divided to a front-end neural network and a back-end neural network, or multiple sets of neural networks will be connected together as a single network so that they can operate corresponding to each other. However, when the target data is changed, neural networks at different ends or of different sets have to be trained again or replaced with new neural networks. Therefore, neural network systems with multiple segments are hard to maintain and thus increase costs.

### SUMMARY

The present disclosure provides a neural network system comprising at least a memory and at least a processor. The memory is configured to store a front-end neural network, an encoding neural network, a decoding neural network, and a back-end neural network. The processor is configured to execute the front-end neural network, the encoding neural network, the decoding neural network, and the back-end neural network in the memory to perform the following operations: utilizing the front-end neural network to output feature data; utilizing the encoding neural network to compress the feature data and output compressed data which correspond to the feature data; utilizing the decoding neural network to decompress the compressed data and output decompressed data which correspond to the feature data; and utilizing the back-end neural network to perform corresponding operations according to the decompressed data.

The present disclosure also provides an operating method for a neural network system comprising: utilizing a front-end neural network to perform a preliminary mission according to raw data and output feature data which correspond to the raw data; utilizing an encoding neural network to compress the feature data and output compressed data which correspond to the feature data; utilizing a decoding neural network to decompress the compressed data and output decompressed data which correspond to the feature data and an advanced mission; and utilizing a back-end neural network to perform the advanced mission according to the decompressed data and output target data.

### BRIEF DESCRIPTION OF THE DRAWINGS

The invention can be more fully understood by reading the following detailed description of the embodiment, with reference made to the accompanying drawings as follows:

FIG. 1 is a diagram illustrating a structure of a neural network according to one embodiment of the present disclosure.

FIG. 2A is a block diagram of a neural network system according to one embodiment of the present disclosure.

FIG. 2B is a diagram illustrating a structure according to the neural network system shown in FIG. 2A.

FIG. 2C is a block diagram of a neural network system according to one embodiment of the present disclosure.

FIG. 3A is a block diagram of a neural network system according to one embodiment of the present disclosure.

FIG. 3B is a diagram illustrating a structure according to the neural network system shown in FIG. 3A.

FIG. 3C is a diagram illustrating a structure according to the neural network system shown in FIG. 3A and FIG. 3B.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

In addition, in the following description and in the claims, the terms “include” and “comprise” are used in an open-ended fashion, and thus should be interpreted to mean “include, but not limited to.” As used herein, the term “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. They are not used to limit the order or limit the invention except that they are specifically indicated in the context.

The structure used for deep learning is a neural network consisting of multiple layers of networks, wherein the output of the first layer is the input of the second layer, and the output of the second layer is the input of the third layer, and so one. Each layer of network has multiple neurons, and the neurons of the adjacent network layers are coupled to each other, and thus an end-to-end structure is constituted. The neurons within a certain network layer are configured to receive data from the neurons within the last network layer and, after performing corresponding calculations, output data to the neurons within the next network layer.

To build a neural network capable of performing intelligent computation, the neural network has to be trained first. By inputting known data into a neural network (or say, a training model), the training model can obtain through calculation stable parameters for neural network, complete the connection configuration of each neuron, and obtain reasonable results. After the training of the training model is finished, the parameters and structure of the neural network are stored as another neural network (or say, an inference model) which is configured to draw inference about unknown data.

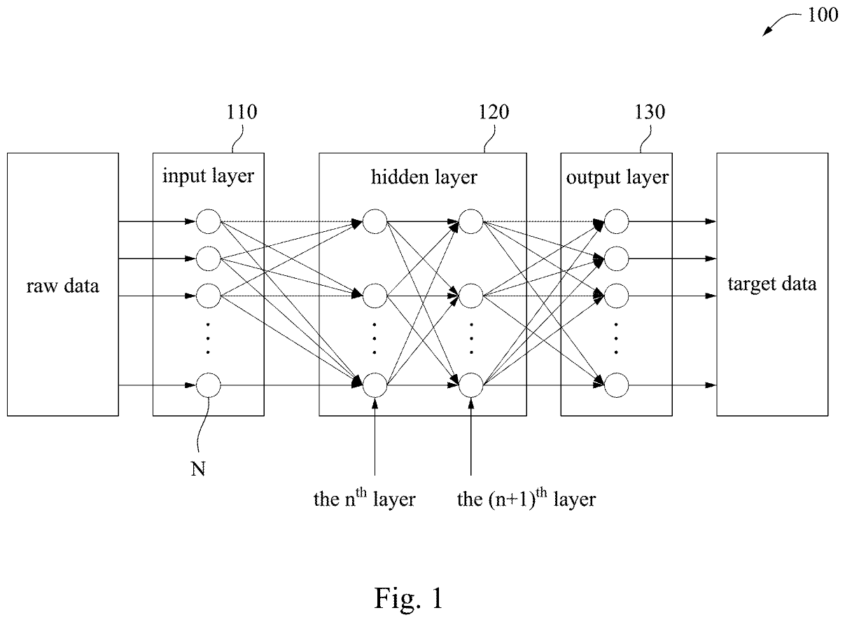

Please refer to FIG. 1. FIG. 1 is a diagram illustrating a structure of a neural network according to one embodiment of the present disclosure.

A neural network 100 includes an input layer 110, a hidden layer 120, and an output layer 130. The input layer 110 is configured to receive multiple nonlinear raw data and output data to the hidden layer 120. The hidden layer 120 is the segment which deals with most calculations of data and parameters of the neural network and outputs data to the output layer 130. The output layer 130 is configured to analyze and weigh the received data and output a result (i.e., the target data). In other words, the neural network 100 as a whole has at least one mission, i.e., to obtain the target data, wherein the mission is carried out by the hidden layer 120, and the answer of the mission is obtained by the output layer 130.

Each of the input layer 110, the hidden layer 120, and the output layer 130 has at least a network layer (not shown in FIG. 1), and each network layer has multiple neurons N. As shown in FIG. 1, the hidden layer 120 has an n^{th} network layer and an (n+1)^{th} network layer, and the n^{th} network layer outputs data to the (n+1)^{th} network layer, wherein n is a positive integer. The number, structure, and sequence of the network layers and the number of the neurons N described in the embodiments of the present disclosure are merely exemplary and do not limit the present disclosure.

In some embodiments of the present disclosure, the neural network 100 is a structure of a deep belief network (DBN), and its hidden layer 120 has network layers which consist of multiple restricted Boltzmann machine (RBM) (not shown in FIG. 1). In some embodiments of the present disclosure, the neural network 100 is a structure of a convolutional neural network (CNN), and its hidden layer 120 has multiple convolutional layers (not shown in FIG. 1), pooling layers (not shown in FIG. 1), and fully-connected layers (not shown in FIG. 1), wherein at least one of the convolutional layers, the pooling layers, and the fully-connected layers has at least one network layer. In the embodiments of the present disclosure, the convolutional neural network is used as exemplary to describe the neural network 100 but does not limit the present disclosure.

For example, the neural network 100 is an inference model with a structure of a convolutional neural network which has been trained by a great number of known animal pictures, and is configured to determine the species of an animal in any picture. From the input raw data (e.g., a picture) to the output target data (e.g., the name of the animal in the picture), the neural network 100 includes, in sequential order, the input layer 110, the hidden layer 120, and the output layer 130, wherein the hidden layer 120 further includes, in sequential order, a first convolutional layer, a first pooling layer, a second convolutional layer, a second pooling layer, a first fully-connected layer, and a second fully-connected layer. Each of the first convolutional layer, the first pooling layer, the second convolutional layer, the second pooling layer, the first fully-connected layer, and the second fully-connected layer can also be referred to as a block, wherein each block includes at least a network layer and has its own computational function.

Following the previous example, the first convolutional layer utilizes a first convolutional kernel to capture a first feature of an input picture, e.g., to obtain the boundaries of the animal image in the picture. Then, the first pooling layer receives and downsamples the data output by the first convolutional layer and output to the second convolutional layer. The second convolutional layer utilizes a second convolutional kernel to capture a second feature of the received data, e.g., to obtain the facial features in the animal image. The second pooling layer receives and downsamples the data output by the second convolutional layer and output to the first fully-connected layer. The first and the second fully-connected layers respectively planarize the received data and output the data to the output layer. Finally, the output layer categorizes the pictures of which the first and second features have been captured and outputs the name of the animal in the picture.

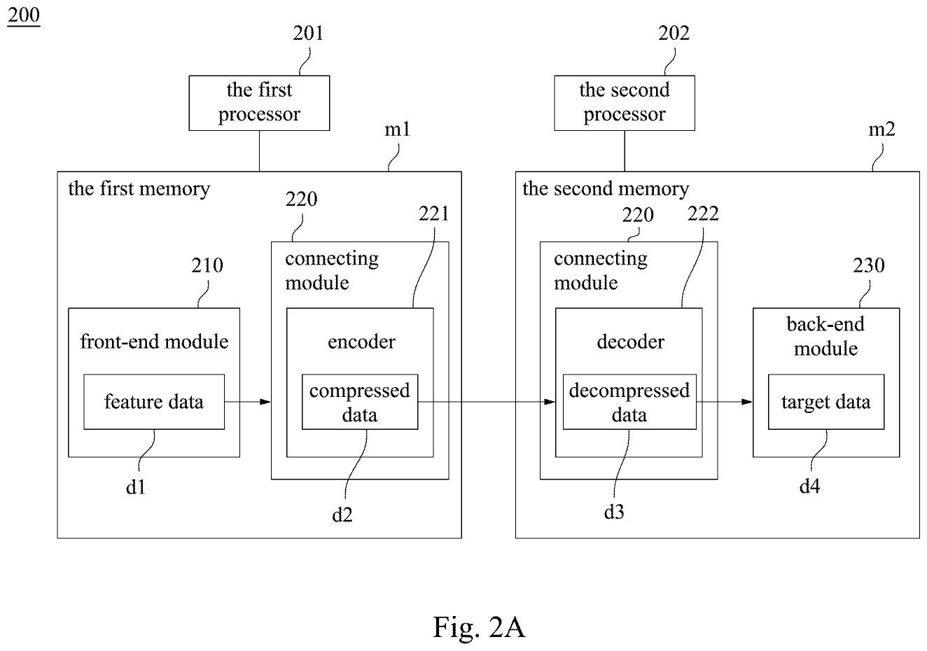

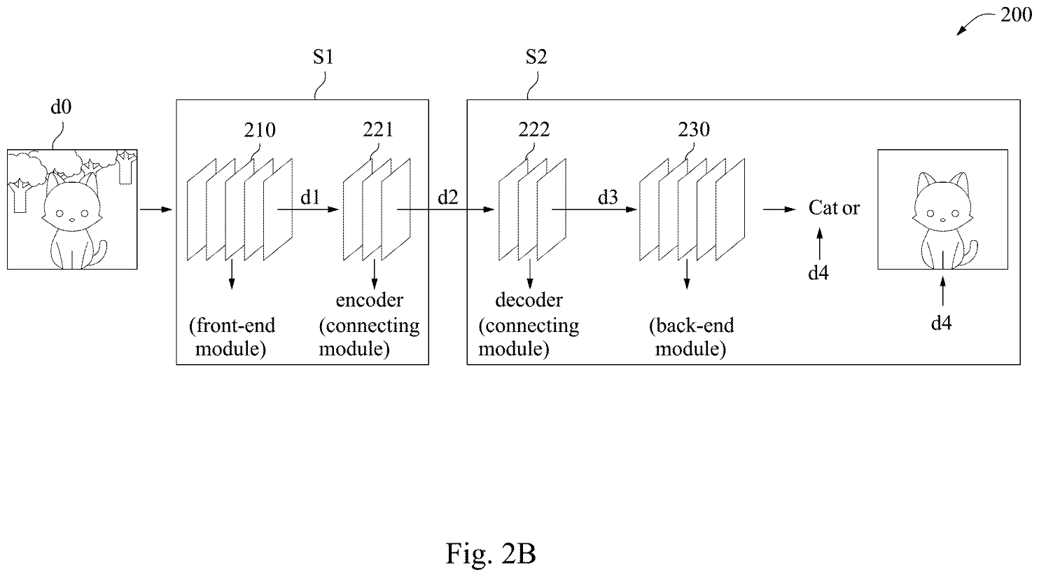

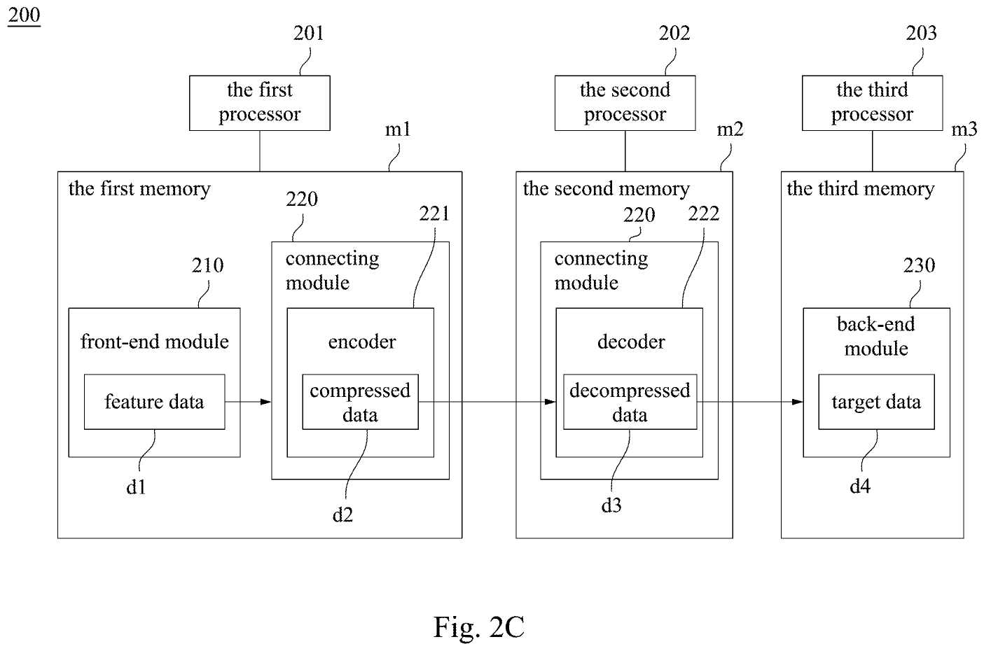

Please refer to FIG. 2A. A neural network system 200 includes a front-end module 210, a connecting module 220, and a back-end module 230.

The front-end module 210, the connecting module 220, and the back-end module 230 are independent neural networks and are individually stored in corresponding memories. In some embodiments of the present disclosure, the front-end module 210 can also be referred to as a front-end neural network. In some embodiments of the present disclosure, the connecting module 220 can also be referred to as a middle-end neural network. In some embodiments of the present disclosure, the back-end module 230 can also be referred to as a back-end neural network.

In some embodiments of the present disclosure, the codes and instructions which are configured to perform the multiple neural network operations abovementioned, the front-end module 210, the connecting module 220, and the back-end module 230 can be stored in more than one memory, e.g., in at least one of a first memory m1, a second memory m2, and a third memory m3 (shown in FIG. 2C). The processor, such as a first processor 201, a second processor 202, or a third processor 203 (shown in FIG. 2C), is configured to encode the codes or instructions in the corresponding memory so that the neural network system 200 performs the corresponding operations as the embodiments of the present disclosure.

In some embodiments of the present disclosure, the front-end module 210, the connecting module 220, and the back-end module 230 are different neural networks with different missions (such as the neural network 100 shown in FIG. 1) and the abovementioned convolutional neural network structure is used as exemplary to describe them. For the brevity of the drawings, FIG. 2A does not show the blocks in the input layer, the hidden layer, and the hidden layer or the output layer of each module, or the corresponding network layer and its neurons.

In some embodiments of the present disclosure, the front-end module 210 and the back-end module 230 have the same neural network structure. In some embodiments of the present disclosure, the front-end module 210 and the back-end module 230 have different neural network structures, including at least two of the VGG16 structure, the Densenet 161 structure, the Faster R-CNN structure, and the YOLO structure. Thus, by using different modules corresponding to different neural network structures to perform different missions (as described below), the efficiency and accuracy of inference can be optimized.

The front-end module 210 and the back-end module 230 are coupled together through the connecting module 220 by the way of data transmission so that the memory usage and inference time of the neural network system 200 can be reduced.

At least one of the front-end module 210, the connecting module 220, and back-end module 230 has a number of network layers different than the other of the three. Therefore, the front-end module 210, the connecting module 220, and back-end module 230 has different computational weights.

In some embodiments of the present disclosure, the front-end module 210 and the back-end module 230 have the same number of blocks, and each block has the same number of corresponding network layers. In some embodiments of the present disclosure, any two of the front-end module 210, the connecting module 220, and the back-end module 230 have different numbers of blocks and corresponding network layers. In some embodiments of the present disclosure, the network layers which the front-end module 210 has are less than those which the back-end module 230 has. In some embodiments of the present disclosure, the network layers which the connecting module 220 has are less than those which the front-end module 210 has and those which the back-end module 230 has.

Please refer to FIG. 2A and 2B together. FIG. 2B is a diagram illustrating a structure according to the neural network system 200 shown in FIG. 2A and describes the operation of the neural network system 200 by use of examples. The neural network system 200 shown in FIG. 2B has a structure similar to the one shown in FIG. 2A, so FIG. 2B does not show or indicate some of the identical components. In addition, for the brevity of the drawings, FIG. 2B does not show the blocks in the input layer, the hidden layer, and the hidden layer or the output layer of each module, or the corresponding network layer and its neurons.

The front-end module 210 is stored in the first memory m1 and operates in the first processor 201. The first processor 201 is coupled to the first memory m1 and cooperates with the first memory m1 in a first device S1. The first processor 201 is configured to encode the front-end module 210 in the first memory m1, utilize the front-end module 210 to perform a preliminary mission, and output a feature data d1 to the connecting module 220.

In some embodiments of the present disclosure, the input layer of the front-end module 210 is configured to receive raw data d0 and output data to the hidden layer of the front-end module 210. The hidden layer of the front-end module 210 is configured to receive data and perform a preliminary mission, i.e., to capture a preliminary feature of the data and output to the output layer of the front-end module 210. Then, the output layer of the front-end module 210 is configured to determine an answer of the preliminary mission, i.e. the feature data d1 and output the feature data d1 to the connecting module 220.

The connecting module 220 includes a encoder 221 and a decoder 222 which are two adjacent blocks in the hidden layer of the connecting module 220, and is configured to change the dimension of the data. Part of the connecting module 220 (such as the encoder 221), together with the front-end module 210, is stored in the first memory m1 and operates in the first processor 201. Part of the connecting module 220 (such as the decoder 222), with the back-end module 230, is stored in the second memory m2 and operates in the second processor 202.

One of the blocks in the hidden layer of the connecting module 220, i.e., the encoder 221, operates in the first processor 201. The first processor 201 is further configured to encode the encoder 221 in the first memory m1, utilize the encoder 221 to reduce the dimension of the feature data d1, and output a compressed data d2 to the decoder 222. In some embodiments of the present disclosure, the encoder 221 is an independent neural network which can also be referred to as an encoding neural network.

Another one of the blocks in the hidden layer of the connecting module 220, i.e., the decoder 222, operates in the second processor 202. The second processor 202 is coupled to the second memory m2 and operates in a second device S2 with the second memory m2. The second processor 202 is configured to encode the decoder 222 in the second memory m2, utilize the decoder 222 to increase the dimension of the compressed data d2, and output a decompressed data d3 to the back-end module 230. In some embodiments of the present disclosure, the decoder 222 is an independent neural network different from the encoder 221 and can be also referred to as a decoding neural network.

In some embodiments of the present disclosure, the input layer of the connecting module 220 is configured to receive the feature data d1 output by the front-end module 210 and output the data to the hidden layer of the connecting module 220. The encoder 221 in the hidden layer is configured to compress the feature data d1 and generate the compressed feature data d1, i.e., compressed data d2. The decoder 222 in the hidden layer is configured to receive the compressed data d2, and the decoder 222 decompresses the compressed data d2 according to an advanced mission which the back-end module 230 shall perform, and generate the decompressed data, i.e., the decompressed data d3. The decoder 222 is further configured to output the decompressed data d3 to the output layer of the connecting module 230. Then, the output layer of the connecting module 220 is configured to output the decompressed data d3 to the back-end module 230.

In some embodiments of the present disclosure, the encoder 221 and the decoder 222 are stored in the same memory and operate in the same processor. The memory can be the first memory m1 or the second memory m2, and the processor can be the first processor 201 or the second processor 202. The processor and the memory operate in the same device. The device can be the first device S1 or the second device S2.

In some embodiments of the present disclosure, the encoder 221 and the decoder 222 are enabled by autoencoders. The encoder 221 and the decoder 222 can learn how to generate the corresponding compressed data d2 and decompressed data d3 according to the primary data and advanced mission. In some embodiments of the present disclosure, the autoencoder learns by fine-tuning. Therefore, by compressing and decompressing data, the mismatch of the dimensions of the compressed data d2 or the decompressed data d3 in the corresponding input and output devices can be reduced, and the neural network parameters used during training can be reduced through fine-tuning.

In some embodiments of the present disclosure, the feature data d1 and the compressed data d2 have different data dimensions. In other words, the compressed d2 has a different data size compared with the feature data d1. In some embodiments of the present disclosure, the data dimension of the feature data d1 is greater than the data dimension of the compressed data d2. For example, the feature data d1 are two-dimension matrix data. The encoder 221 is configured to compress the two-dimension matrix data into one-dimension array data so that the data dimension of the compressed data d2 is smaller than the data dimension of the feature data d1. In other words, the feature data d1 is a picture with 1024-pixel resolution, and the encoder 221 is configured to compress this picture into a picture with 480-pixel resolution, i.e., the compressed d2. Therefore, the data transmitted between the encoder 221 and the decoder 222 have the same data dimension, i.e., the data dimension of the compressed data d2. By this way, the amount of data transmitted between the front-end module 210 and the back-end module 230 can be reduced, and thus data transmission can be faster.

In some embodiments of the present disclosure, the feature data d1 and the decompressed data have different data dimensions. In some embodiments, the data dimension of the feature data d1 is greater than the data dimension of the decompressed data d3. Following the example above, the decoder 222 is configured to decompress the compressed data d2 into a picture with 720-pixel resolution, i.e. the decompressed data d3. Likewise, the amount of data transmitted between the front-end module 210 and the back-end module 230 can be reduced, and thus data transmission can be faster.

In some embodiments, the feature data d1 and the decompressed data d3 have the same data dimension. For example, the feature data d1 is a picture with 1024-pixel resolution, and the encoder 221 is configured to compress the picture into a picture with 720-pixel resolution, i.e., the compressed data d2, and the decoder 222 is configured to decompress the compressed data d2 into a picture with 1024-pixel resolution, i.e., the decompressed d3. By this way, when the back-end module 230 which is placed after the decoder 222 is replaced with a new back-end module 230 (another neural network), the data dimension of the decoder 222 can be changed and increased in order to respond to the new back-end module 230. Therefore, the decoder 222 need not be changed according to the new back-end module 230.

As shown in FIG. 2A, the back-end module 230 and part of the connecting module 220 (e.g. the decoder 222) are stored in the second memory m2 and operate in the second processor 202. The second processor 202 is further configured to encode the back-end module 230 in the second memory m2, utilize the back-end module 230 to perform the advanced mission, and output a target data d4. The answer of the inference of the neural network system 200 is thus shown.

In some embodiments, the input layer of the back-end module 230 is configured to receive the decompressed data d3 and output data to the hidden layer of the back-end module 230. The hidden layer of the back-end module 230 is configured to receive data and perform the advanced mission, i.e. to capture an advanced feature of the data and output to the output layer of the back-end module 230. Then, the output layer of the back-end module 230 is configured to determine the answer of the advanced mission, i.e., the target data d4, and output the target data d4 to the display of other device (not shown in FIG. 2A).

The advanced mission performed by the back-end module 230 is associated with the preliminary mission performed by the front-end module 210. Therefore, the target data d4 are the data obtained after performing data processing (e.g., convolution) to the decompressed data d3. In other words, the target data d4 include the preliminary and advanced features of the raw data d0. Therefore, the back-end module 230 can be configured to perform the corresponding operations in the advanced mission according to the preliminary and advanced features and generate the target data d4.

Please refer to FIG. 2C. The neural network system 200 of one embodiment of the present disclosure includes the front-end module 210, the connecting module 220, and the back-end module 230. The neural network system shown in FIG. 2C is similar to the one shown in FIG. 2A, and thus the similarities will not be described again.

Compared with the embodiment shown in FIG. 2A, in the embodiment shown in FIG. 2C, the back-end module 230 is stored in another independent memory (i.e., a third memory m3) and operates in another independent processor (i.e., a third processor 203).

As shown in FIG. 2C, part of the connecting module 220 (e.g., the decoder 222) is stored in the second memory m2 and operates in the second processor 202. The back-end module 230 is stored in the third memory m3 and operates in the third processor 203.

The second processor 202 and the second memory m2 operate in the same device, e.g., one of the first device S1 shown in FIG. 2B), the second device S2 (shown in FIG. 2B), and a third device (not shown in FIG. 2B). The third processor 203 and the third memory m3 operate in another device, e.g., another one of the first device S1 (shown in FIG. 2B), the second device S2 (shown in FIG. 2B), and the third device.

In some embodiment, the hidden layer of the front-end module 210 or the back-end module 230 is enabled by a feature extractor including a structure which is formed by piling multiple convolutional-batch normalization-ReLU units in sequential order, in order to have different extent of feature extraction to the picture.

In the embodiment shown in FIG. 2A and 2B, the neural network system 200 is configured to make inference about a certain picture and obtain a certain answer, e.g., to obtain the names of all animals appearing in the picture.

As shown in FIG. 2B, the raw data d0 input into the neural network system 200 is a picture including a background and a cat. The neural network system 200, through performing the preliminary and advanced missions, captures the corresponding preliminary and advanced features respectively in order to distinguish the species of the animal appearing in the raw data d0, and shows the common name of the animal or indicates the final inference answer in the original picture, i.e., the “Cat” shown by the target data d4 or the answer of the picture shown in FIG. 2B.

In other words, the neural network system 200 divides an inference process into multiple segments of neural networks performing respectively, wherein each segment of neural networks can have the same or different structure. Compared with the structure of the original neural network, the hidden layer of the divided neural network (e.g., the front-end module 210 or the back-end module 230) has been removed. Through the connecting module 220 in the middle, structure the hidden layer shared by multiple divided neural networks in order to integrate as the entirety of the neural network system 200.

Throughout the operation of inference, first, the front-end module 210 performs the preliminary mission to obtain the contours of each picture(i.e., the preliminary feature), and then the back-end module 230 performs the advanced mission to obtain the facial features of the animal in the picture(i.e., the advanced feature), so that the final answer (i.e., “Cat”) can be inferred.

As described above, the neural network system 200 divides the inference process into multiple segments of missions, enhances the computational efficiency and accuracy of each neural network by lowering the loading of single computation, and thus increases the overall inference efficiency of the neural network system 200.

In some embodiments, the neural network system 200 can change its original inference purpose corresponding to developmental or maintenance need. For example, the inference purpose of the neural network system 200 is expanded or changed from inferring the names of all animals in the picture to inferring the names of all plants in the picture. Because the front-end module 210 and the back-end module 230 perform different missions individually, and the missions are all relevant to identifying the image in the picture, when the inference purpose is changed, by adding or replacing the front-end module 210 or the back-end module 230 with another neural network configured to identify features of plant, only the connecting module 220 between two missions which is configured to compress and decompress feature data d1 needs to be trained again, while the whole neural network system does not have to be trained again.

For example, the preliminary is still to obtain the contours of each image in the picture, while the advanced mission is changed from obtaining the animal features in the picture into obtaining the plant features in the picture. Here, the back-end module 230 which performs the advanced mission does not have to be trained again. The developer or maintainer can merely replace the front-end module 210 with another neural network configured to identify plant features (e.g., capture the contour features of plant) and train the encoder 221 and/or the decoder 222 again, so that the compressed data d2 and the decompressed data d3 will include the advanced features of plant image.

In another example, the inference purpose of the neural network system 200 is changed from inferring the names of all animals in the picture to inferring the fur colors of all animals in the picture. Here, because the front-end module 210 and the back-end module 230 perform different missions and the preliminary mission is a basic operation relating to identify the contours of image, only the back-end module 230 and the connecting module 220 have to be trained again, while the whole neural network system 200 does not have to be trained again.

For example, the preliminary mission is still to obtain the contours of each image in the picture, while the advanced mission is changed from obtaining the features of animals in the picture to obtaining the feature and color of the animal's fur. Here, the front-end module 210 which performs the preliminary mission does not have to be trained again, and the developer or the maintainer only has to train the encoder 221 and/or the decoder 222 and the back-end module 230 again, so that the compressed data d2 and the decompressed data d3 include the changed advanced features described above and the back-end module 230 corresponds to the changed advanced mission.

In addition, because the front-end module 210, the connecting module 220, and the back-end module 230 operate in different processors and correspond to different memories, the hardware resource of the neural network system 200 can be decentralized. By this way, the memory storage used when the neural network system 200 is operating can be effectively reduced. Especially when the inference purpose is changed, as described above, the neural network system 200 can only train part of the modules in the corresponding device, and thus the neural network parameters generated during the training and the memory resource used correspondingly can be greatly reduced, and the computational time required for the training can be improved.

In some embodiments, the first device S1 and the second device S2 are different hardware devices which include a mobile device (e.g., a smart phone or pad), a cloud server or a database server, and so on.

In sum, when the inference purpose of the neural network system 200 is changed, the whole system does not have to trained again, but only the connecting module 220 and/or the back-end module 230 placed in different devices have to be trained again. Therefore, the neural network system 200 has great flexibility and efficiency in terms of development or maintenance and can lower the time and cost for training.

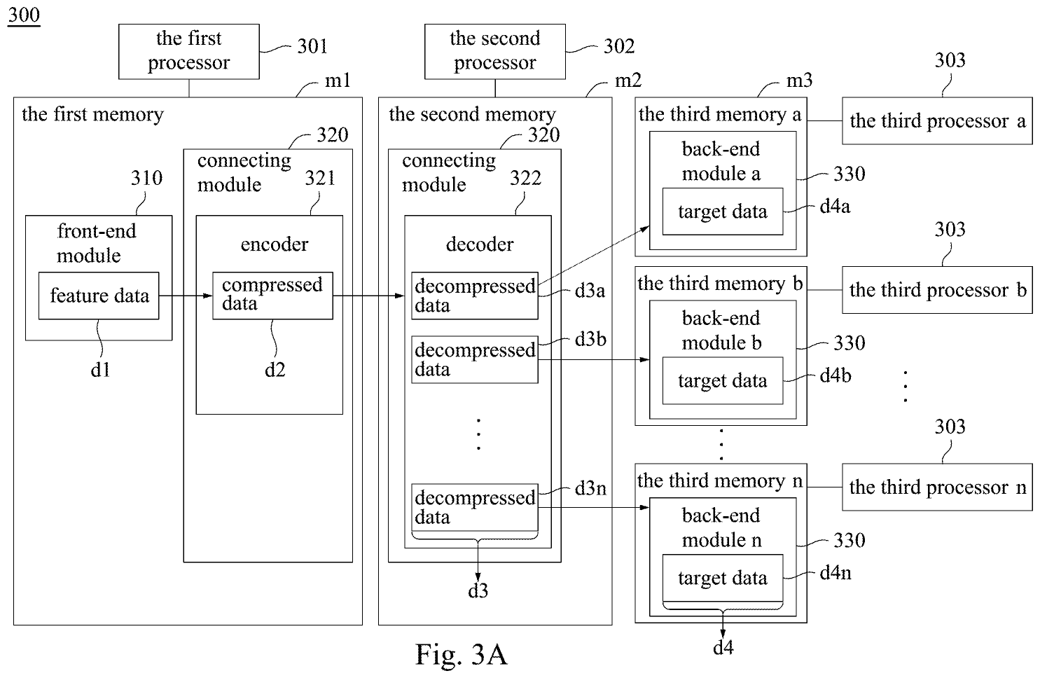

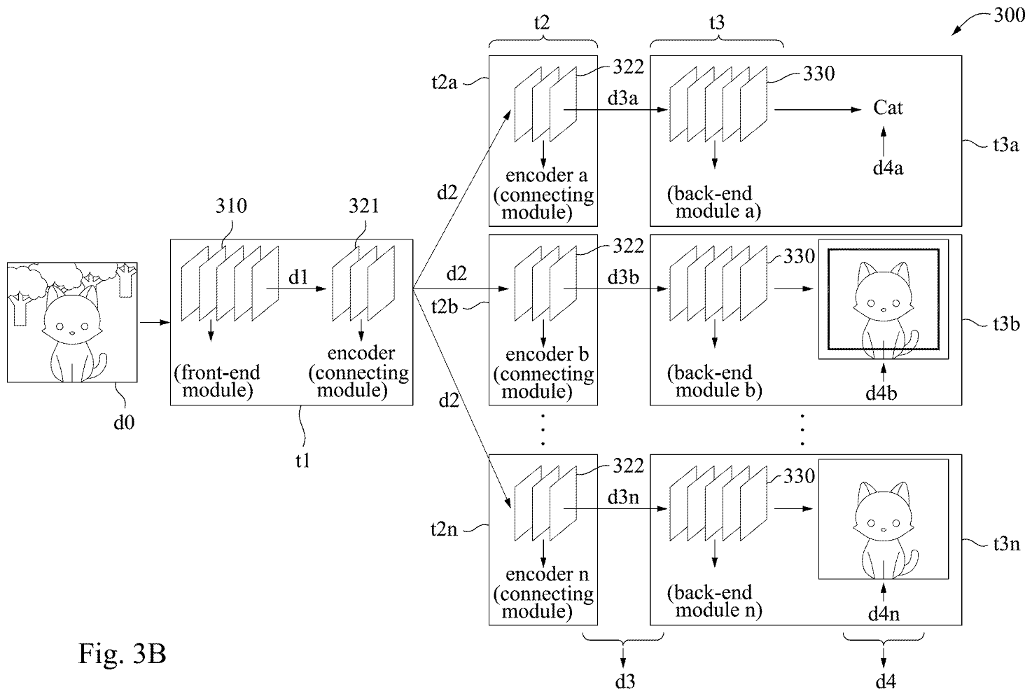

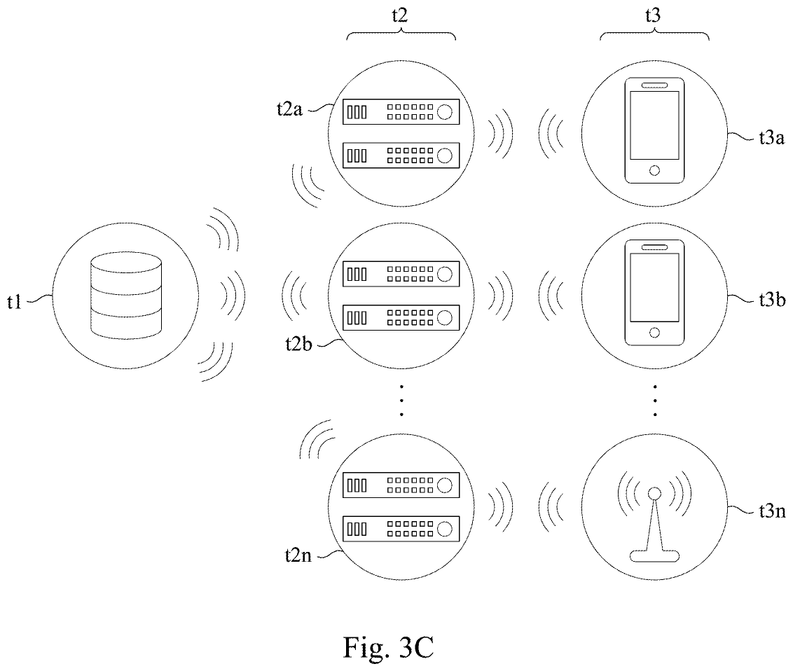

Please refer to FIG. 3A. Another embodiment of the present disclosure is a neural network system 300 which includes a front-end module 310, a connecting module 320, and multiple back-end modules 330.

The front-end module 310, the connecting module 320, and the back-end modules 330 are independent neural networks and are stored in the corresponding memories individually. In some embodiments, the front-end module 310 can also be referred to as a front-end neural network. In some embodiments, the connecting module 320 can also be referred to as a middle-end neural network. In some embodiments, the back-end module 330 can also be referred to as a back-end neural network.

In some embodiments, the codes and instructions configured to perform the multiple neural network operations abovementioned, the front-end module 310, the connecting module 320, and the back-end modules 330 can be stored in more than one memory, including at least one of the first memory m1, the second memory m2, and multiple third memories m3. The processor, e.g., the first processor 301, the second processor 302, or any of the third processors 303, is configured to encode the codes or instructions in the corresponding memory so that the neural network system 300 can perform the operations in the embodiments of the present disclosure.

In some embodiments, the front-end module 310, the connecting module 320, and the back-end modules 330 are different neural networks with different missions (such as the neural network 100 shown in FIG. 1), and the convolutional neural network structure abovementioned is used as exemplary to describe them. The neural network system shown in FIG. 3A is similar to the one shown in FIG. 2A, and thus the similarities will not be described again. For the brevity of the drawing, FIG. 3A does not show the blocks in the input layer, the hidden layer, or the hidden layer, the output layer, or the corresponding network layer and its neurons.

In some embodiments, at least one of the front-end module 310 and the back-end modules 330 has the same neural network structure. In some embodiments, at least one of the front-end module 310 and the back-end modules 330 has a different neural network structure, including at least two of the VGG16 structure, the Densenet 161 structure, the Faster R-CNN structure, and the YOLO structure, wherein the type of the structure is designed according to its own mission so that a great inference accuracy can be achieved.

In some embodiments, the connecting module 320 is enabled by an autoencoder which is configured to learn and adjust the size of the connecting module 320′s hidden layer to connect the front-end modules 310 with the same or different structures, so that the memory storage used and the time required for inference of the neural network system 300 can be reduced.

In some embodiments, each of the back-end modules 330 has the same number of network layers. In some embodiments, at least two of the back-end modules 330 have different numbers of network layers. Therefore, the front-end module 310, the connecting module 320, or each of the back-end modules 330 has different computational weights and are configured to perform different missions at the same time.

Please refer to FIG. 3A and 3B together. FIG. 3B is a diagram illustrating a structure according to the neural network system 300 shown in FIG. 3A and describes the operation of the neural network system 300 by examples. The structure of the neural network system in FIG. 3B is similar to the one shown in FIG. 3A, and thus FIG. 3B does not show or indicate some of the identical components. The neural network system shown in FIG. 3B is partially similar to the one shown in FIG. 2B, and thus the similarities are not described again. In addition, for the brevity of the drawing, FIG. 3B does not show the block or the output layer in the input layer, the hidden layer, or the hidden layer of each module, or the corresponding network layer and its neurons.

The connecting module 320 includes a encoder 321 and multiple decoders 322 which are the adjacent blocks in the hidden layer, wherein the multiple decoders 322 are parallel blocks which are configured to change the data into different or the same dimension. In some embodiments, the encoder 321 and the multiple decoders 322 are independent neural networks. In some embodiments, the encoder 321 can also be referred to as an encoding neural network, and the decoder 322 can also be referred to as a decoding neural network.

The encoder 321 and the front-end module 310 operate in the first processor 301 together. The first processor 301 is coupled in the first memory m1 and operates with the first memory m1 in the first device t1. The first processor 301 is configured to encode the encoder 321 in the first memory m1, lower the dimension of the feature data d1, and output the compressed data d2 to each of the decoders 322.

A decoder 322 corresponds to one or multiple back-end modules 330, and the decoder 322 operates in the second processor 302. The second processor 302 is coupled in the second memory m2 and operates in the second device t2 different from the first device t1. The second processor 302 is configured to encode the decoder 322 in the second memory m2, increase the dimension of the compressed data d2 according to the advanced mission of the back-end module 330, and output the corresponding decompressed data d3 to the corresponding back-end module 330. The numbers of the second processors 302 and the decoders 322 as shown in FIG. 3A are merely exemplary. There can be multiple second processors 302 and corresponding decoders 322 (such as the decoder a, b, or n shown in FIG. 3B) which operate in multiple second devices t2 (such as the second devices t2a, t2b, or t2n shown in FIG. 3B) individually.

In some embodiments, the front-end module 310 and the encoder 321 are all installed in a chip and operate in the first device t1 (such as a server). Therefore, the common feature data d1 will be stored in the chip and is configured to transmit to the second device t2. By this way, for the developer of the neural network system 300, preceding operations can be researched and developed in the second device t2 all together, and then the compressed feature data d1 can be output according to the corresponding advanced mission placed after. Therefore, it is convenient to modify the preliminary mission of the preceding operation, e.g. to change from identifying image to identifying sound. The corresponding advanced mission placed after therefore has multiple possible combinations in order to achieve great application flexibility.

In addition, each of the back-end modules 339 operates in the corresponding third processor 303. The third processor 303 is coupled in the third memory m3 and operates in the third device t3, which is different from the first device t1 and the second device t2, with the third memory m3. Each of the third processors 303 is configured to encode the back-end module 330 in the corresponding third memory m3 and perform the corresponding operation. For example, the back-end module a operates in third processor a, and the third processor a is coupled in the third memory a and operates in the third device t3a with the third memory m3a. The third processor a is configured to encode the back-end module a in the third memory m3a. The numbers of the third processors 303 and the third memories m3 in the embodiments of the present disclosure are merely exemplary and do not limit the present disclosure.

Each of the back-end modules 330 corresponds to a decoder 322 and is configured to perform the corresponding operation. For example, as shown in FIG. 3B, the decoder a operates in the second device t2a, the back-end module a operates in the third device t3a, and the decoder a is configured to generate the decompressed data d3a according to the advanced mission of the back-end module a. The decoder b operates in the second device t2b, the back-end module b operates in the third device t3b, and the decoder b is configured to generate the decompressed d3b according to the advanced mission of the back-end module b. The decoder n operates in the second device t2n, the back-end module n operates in the third device t3n, and the decoder n is configured to generate the decompressed data d3n according to the advanced mission of the back-end module n, wherein n is a positive integer and does not limit the actual number. The second device t2a, the second device t2b, and the second device t2n are different hardware devices. The third device t3a, the third device t3b, and the third device t3n are different hardware devices and are coupled to the second device t2 and the first device t1, and thus form a internet-of-thing system.

In some embodiments, as shown in FIG. 3C, the first device t1 is a database server. The second device t2a, t2b, and t2n are servers mounted at the user's end and are independent servers. The third device t3a and t3b are smart phones and are devices held by users, and are configured to show the corresponding target data d4a and d4b. The third device t3n is a wireless device (such as a Bluetooth receiver or a display device with wi-fi component) and is a device held by a user, and is configured to output or display the corresponding target data d4n.

Each decompressed data d3 has different data dimension, and the data dimension of the compressed data d2 is smaller than data dimension one of each decompressed data d3. The data dimension of each decompressed data d3 depends on the corresponding advanced mission so that great inference accuracy in the corresponding back-end module 330 can be achieved.

Each of the back-end modules 330 is configured to perform its own advanced mission to capture the advanced feature of the corresponding decompressed data d3 and output the corresponding target data d4 in order to display multiple inference answers of the whole neural network system 300.

In some embodiments of the related arts, when the quality of data transmission between any two of the first device t1, the second device t2, and the third device t3b is low, e.g. the signal bandwidth is low or electromagnetic interference is present, the transmission of data with large file capacity can be instable.

Compared with the embodiments abovementioned, in the embodiments of the present disclosure, the data (e.g., the compressed data d2 or the decompressed data d3) has great stability for transmission between different devices because the file capacity (i.e., the data dimension) of the data is adjusted and lowered by the connecting module 320.

In the embodiments shown in FIG. 3A to 3C, the neural network system 300 is configured to make inference about a certain picture and obtain multiple answers.

As shown in FIG. 3B, the raw data d0 input into the neural network system 300 is a picture including a background and a cat. The neural network system 300, by performing the preliminary mission and multiple advanced missions, captures the corresponding preliminary feature and multiple advanced features respectively, in order to identify the animal in the picture and at the same time displays the final answer in different ways, including showing the common name of the animal, indicating the animal in the original picture, or capturing and outputting the animal in the original picture.

In some embodiments, each of the advanced missions is independent and not associated with each other. In some embodiments, each advanced mission is relevant to each other. For example, as shown in FIG. 3B, the back-end module a is configured to capture the first advanced feature of the decompressed data d3a and obtain the answer of “Cat” through inference, the back-end module b is configured to capture the second advanced feature of the decompressed data d3b and obtain through inference the answer of circling the animal appearing in the picture, such as the target data d4b shown in FIG. 3B, and the back-end module n is configured to capture the n^{th} advanced feature of the decompressed data d3n and obtain through inference the answer of the animal image in the picture, as the target data d4n shown in FIG. 3B.

In other words, the neural network system 300 divides an inference process into multiple segments of neural networks and performs them at the same time. First, the front-end module 310 performs the preliminary mission to obtain the contours of each image in the picture (i.e., the preliminary feature), and then multiple parallel back-end modules 330 perform the corresponding advanced missions at the same time to obtain the facial features of the animal in the picture (i.e., the first advanced feature), the contours of the animal in the picture (i.e., the second advanced feature), and the contours of the animal and the background in the picture (i.e., the n^{th} advanced feature), so that the final answer (e.g., the target data d4a, d4b, and d4n shown in FIG. 3B) can be inferred.

The advanced mission which each back-end module 330 is required to perform is associated with the preliminary mission. In other words, each advanced mission needs to perform the corresponding operation according to the feature data d1. That is, the preliminary mission performed by the front-end module 310 is the preceding operation of the advanced mission which each back-end module performs.

In some embodiments, multiple target data d4 are inferred by performing the corresponding operations according to the raw data d0 as shown in FIG. 3B. Below uses examples to describe the difference of efficiency between traditional neural network system and the neural network system 300 of the embodiments in the present disclosure.

The traditional neural network system includes four neural networks which have different missions and are configured to perform four missions individually and simultaneously, wherein the missions include two missions of object classification and two missions of object detection. Each neural network has a structure of multiple segments and has multiple segments of block to correspond to a mission.

For example, the traditional neural network system includes a neural network which has a VGG 16 structure and is configured to perform a mission of object classification, a neural network which has a Densenet 161 structure and is configured to perform another mission of object classification, a neural network which has a Faster R-CNN structure and is configured to perform a mission of object detection, and a neural network which has a YOLO structure and is configured to perform another mission of object detection.

According to the embodiments of the present disclosure, the neural network system 300 configured to perform the abovementioned four missions correspondingly includes the front-end module 310, the encoder 321, four decoders 322, and four corresponding back-end modules 330. The front-end module 310 includes the first to the fourth blocks in the Densenet 161 structure, which are configured to perform the preceding operation of object classification and detection. The back-end module a includes the fifth block in the VGG 16 structure and is configured to perform a mission of object classification. The back-end module b includes all blocks in the Densenet 1151 structure and is configured to perform another mission of object classification. The back-end module c (not shown in FIG. 3B) includes all blocks in the Faster R-CNN structure and is configured to perform a mission of object detection. The back-end module n includes the fifth and sixth blocks in the YOLO structure and is configured to perform another mission of object detection.

During the inference process of the traditional neural network system, the memory capacity used is around 25540 megabyte (MB), and the whole process takes about 0.127 second. Compared with the traditional neural network system, for the neural network system 300 of the embodiment of the present disclosure, the memory capacity used is around 17440 MB, and the whole process takes around 0.097 second. Therefore, compared with the traditional neural network system, the neural network system 300 of the present disclosure can reduce around 32% of the memory usage and reduce around 23% of computation time.

In some embodiments, the neural network system 300 includes multiple front-end modules 310, the connecting module 320, and at least one back-end module 330 which have different missions, while the numbers of the front-end module 310, the back-end module 330, or the corresponding blocks and network layers are not limited here, and the numbers and content of the preliminary mission and advanced mission are not limited here, either.

As described above, the neural network system 300 divides the inference process into at least a preliminary mission and at least an advanced mission in order to increase the computational efficiency and accuracy of each network layer. The preliminary mission is associated with multiple advanced missions and is configured to perform the cooperation of the advanced missions in order to capture the preliminary feature which each advanced mission needs. By this way, the inference efficiency of the neural network system 300 can be increased.

In some embodiments, the neural network system 300 can change its original inference purpose according to developmental or maintenance need. Like the embodiments abovementioned, when the inference purpose is changed, only the connecting module 320 which is between the front end and the back end and is configured to compress and decompress feature data d1 needs to be trained again, while the whole neural network system 300 does not have to be trained again. Or, only the replaced back-end module 330 and the connecting module 320 need to be trained again, while the whole neural network system 300 does not have to be trained again.

In sum, the neural network system can assist the development and maintenance of the whole system and reduce computation time and save memory resource.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A neural network system, comprising:
at least one memory configured to store a front-end neural network, an encoding neural network, a decoding neural network, and a back-end neural network; and
at least one processor configured to execute the front-end neural network, the encoding neural network, the decoding neural network, and the back-end neural network stored in the at least one memory for performing the following operations:
utilizing the front-end neural network to output feature data;
utilizing the encoding neural network to compress the feature data and output compressed data corresponding to the feature data;
utilizing the decoding neural network to decompress the compressed data and output decompressed data corresponding to the feature data; and
utilizing the back-end neural network to perform corresponding operations according to the decompressed data.

2. The neural network system of claim 1, wherein the at least one processor is further configured to execute the front-end neural network, the encoding neural network, the decoding neural network, and the back-end neural network stored in the at least one memory for performing the following operations:
utilizing the front-end neural network to perform a preliminary mission according to raw data and output the feature data corresponding to the raw data; and
utilizing the back-end neural network to perform an advanced mission associated with the preliminary mission according to the decompressed data and output target data according to the decompressed data.

3. The neural network system of claim 2, wherein the at least one processor is further configured to execute the front-end neural network, the encoding neural network, the decoding neural network, and the back-end neural network stored in the at least one memory for performing the following operations:
in response to the advanced mission being changed, utilizing the decoding neural network to decompress the compressed data according to the feature data and the changed advanced mission.

4. The neural network system of claim 1, wherein a data dimension of the feature data is larger than a data dimension of the compressed data.

5. The neural network system of claim 1, wherein a data dimension of the feature data is larger than or equals to a data dimension of the decompressed data.

6. The neural network system of claim 1, wherein,
the at least one memory comprises:
a first memory configured to store the front-end neural network and the encoding neural network; and
a second memory configured to store the decoding neural network and the back-end neural network; and
the at least one processor comprises:
a first processor configured to execute the front-end neural network and the encoding neural network stored in the first memory; and
a second processor configured to execute the decoding neural network and the back-end neural network stored in the second memory.

7. The neural network system of claim 1, wherein,
the at least one memory comprises:
a first memory configured to store the front-end neural network and the encoding neural network;
a second memory configured to store the decoding neural network; and
a third memory configured to store the back-end neural network; and
the at least one processor comprises:
a first processor configured to execute the front-end neural network and the encoding neural network stored in the first memory;
a second processor configured to execute the decoding neural network stored in the second memory; and
a third processor configured to execute the back-end neural network stored in the second memory.

8. An operating method, suitable for a neural network system, the operating method comprising:
utilizing a front-end neural network to perform a preliminary mission according to raw data and output feature data corresponding to the raw data;
utilizing at least one encoding neural network to compress the feature data and output compressed data corresponding to the feature data;
utilizing at least one decoding neural network to decompress the compressed data and output decompressed data corresponding to the feature data and at least one advanced mission; and
utilizing at least one back-end neural network to perform the advanced mission according to the decompressed data and output target data.

9. The operating method of claim 8, further comprising:
in response to the advanced mission being changed, utilizing the decoding neural network to decompress the compressed data according to the feature data and the changed advanced mission.

10. The operating method of claim 8, wherein,
the at least one back-end neural network comprises a plurality of back-end neural networks;
the at least one advanced mission comprises a plurality of advanced missions, at least one of the plurality of back-end neural networks utilizes the decompressed data with a first data dimension, the decompressed data with the first data dimension is utilized to correspondingly perform at least one of the advanced missions; and
at least one of the plurality of back-end neural networks utilizes the decompressed data with a second data dimension different from the first data dimension, the decompressed data with the second data dimension is utilized to correspondingly perform at least one of the advanced missions.

11. The operating method of claim 8, wherein a data dimension of the feature data is larger than a data dimension of the compressed data.

12. The operating method of claim 8, wherein a data dimension of the feature data is larger than or equals to a data dimension of the decompressed data.

13. The operating method of claim 8, wherein,
the at least one back-end neural network comprises a plurality of back-end neural networks,
the at least one advanced mission comprises a plurality of advanced missions, and
the operating method comprises:
utilizing the plurality of back-end neural networks to individually perform the corresponding advanced missions associated with the preliminary mission.
